(19) United States
(12) Patent Application Publication
(10) Pub. No.: US 2026/0312513 A1
(43) Pub. Date: Oct. 8, 2026

(54) CONTROL METHOD, CALIBRATION METHOD AND ELECTRIC MOTOR

(71) Applicant: Robert Bosch GmbH, Stuttgart (DE)

(72) Inventors: Michael Strupp, Durmersheim (DE); Timo Kuehn, Oetigheim (DE)

(21) Appl. No.: 19/483,689

(22) PCT Filed: May 14, 2024
(86) PCT No.: PCT/EP2024/063141

§ 371 Date: Nov. 12, 2025

(30) Foreign Application Priority Data
May 15, 2023 (DE) 10 2023 204 551.6

(51) Int. Cl. H02P 6/10; H02P 6/14

(52) U.S. Cl. CPC H02P 6/10; H02P 6/14; H02P 2205/00; H02P 2207/05; H02P 2209/11

(57) ABSTRACT

The invention relates to a control method for an electric motor (10), in particular a brushless DC motor, preferably a permanent-magnet-excited synchronous motor, comprising a stator (14) having at least one coil (12) and comprising a rotor (18) having at least one permanent magnet (16), which rotor, during operation, is rotated relative to the stator (14), and comprising an open- and/or closed loop control unit (20), in particular a microprocessor, by means of which, depending on a rotational angle (22) of the rotor (18) to the stator (14), an output voltage (24) for driving the rotor (18) is specified.

It is proposed that the output voltage (24) is specified such that a harmonic coil current (28) flowing during operation, in particular in addition to a basic oscillation coil current, is set at least substantially to a value determined in at least one calibration step (30).

### BACKGROUND

A control method for an electric motor with a stator comprising at least one coil and a rotor comprising at least one permanent magnet, which rotor, during operation, is rotated relative to the stator, and comprising at least one open- and/or closed-loop control unit, in particular a microprocessor, by means of which, depending on a rotational angle of the rotor to the stator, an output voltage for driving the rotor is specified, has already been proposed.

### SUMMARY

The invention proceeds from a control method for an electric motor, in particular a brushless DC motor, preferably a permanent-magnet-excited synchronous motor, comprising a stator having at least one coil and comprising a rotor having at least one permanent magnet, which rotor, during operation, is rotated relative to the stator, and comprising at least one open- and/or closed-loop control unit, in particular a microprocessor, by means of which, depending on a rotational angle of the rotor to the stator, an output voltage for driving the rotor is specified.

It is proposed that the output voltage is specified such that a harmonic coil current flowing during operation, in particular in addition to a basic oscillation current, is set at least substantially to a value determined in at least one calibration step.

Due to the design of the control method according to the invention, a high level of comfort can advantageously be provided, as a low vibration-related noise emission NVH (Noise oscillations Harshness) is provided, in particular by setting the harmonic coil current. Advantageously, a particularly precise operation can be provided, as an occurrence of torque fluctuations, preferably torque ripple, can be prevented in particular by setting the harmonic coil current. Advantageously, low costs can be provided, as already existing drives can in particular be improved with an update. Advantageously, a particularly high performance can be provided at advantageously consistent costs, as a low noise emission can be achieved with a simultaneously low computing power of the open- and/or closed-loop control unit in particular by setting the harmonic coil current.

The electric motor is preferably designed as a brushless DC motor (BLDC). In particular, the BLDC is configured as a permanently excited synchronous motor. The electric motor is preferably configured as an external rotor electric motor. Alternatively, the electric motor could also be configured as an internal rotor electric motor. Preferably, the electric motor comprises an electronic circuit, preferably an inverter circuit, which converts at least one DC current to an electric power supply of the electric motor to a multi-phase alternating current, in particular a three-phase current. Preferably, the electric motor comprises a stator comprising at least one, preferably at least three, coils. Preferably, the rotor comprises at least one, preferably at least two, permanent magnets. In particular, the at least one permanent magnet comprises at least one pole, preferably at least two different poles. It is conceivable that the rotor has a plurality of permanent magnets arranged in particular around the circumference of the rotor, which has north and south poles arranged around the circumference of the rotor, preferably in an alternating fashion. Preferably, the number of coils of the stator is greater than the number of permanent magnets of the rotor. It is conceivable that the stator has the same number of coils as the number of permanent magnets of the rotor. The electric motor comprises at least one open- and/or closed-loop control unit. Preferably, the open- and/or closed-loop control unit is configured as a microcontroller. Alternatively, the open-and/or closed-loop control unit could be configured at least in part as a cloud. Preferably, the open- and/or closed-loop control unit is configured to provide at least one output voltage signal for driving the electric motor. Preferably, the electronic circuit generates the output voltage specified by the open- and/or closed-loop control unit. The term “open- and/or closed-loop control unit” should in particular be understood to mean a unit comprising at least one control electronics. The term “control electronics” should in particular be understood to mean a unit comprising a processor unit and comprising a memory unit as well as an operating program stored in the memory unit. In particular, at least one electronic component, such as a semiconductor chip, comprising a processor and/or RAM and program memory and/or peripheral functions, is to be understood as a “microcontroller”.

Preferably, the output voltage signal provided by the open- and/or closed-loop control unit is converted into an output voltage. Preferably, the output voltage is generated and/or converted by the electronic circuit. Preferably, a multi-phase, in particular three-phase, alternating current is generated by the electronic circuit. Preferably, the output voltage signal depends on the rotational angle of the rotor relative to the stator. Preferably, the coil voltage has a sign change during rotation of the rotor, which repeats itself, in particular periodically. Preferably, during operation of the electric motor, preferably during rotation of the rotor around the stator and/or during provision of a motor torque, a preferably sinusoidal basic oscillation coil current is generated from the output voltage applied to the at least one coil. Preferably, a coil voltage is induced in the coils of the stator by the permanent magnets, in particular during movement of the rotor, which generates a harmonic coil current superposed on the basic oscillation coil current, in particular an integer multiple of the basic oscillation coil current. Preferably, the harmonic coil current is generated by the induced harmonic coil voltage. Preferably, the harmonic coil current depends at least on a coil resistance and a coil inductance. Preferably, the harmonic coil current is changed by changing/adjusting a difference between the induced harmonic coil voltage and the output voltage provided by the electronic circuit. Preferably, the harmonic coil current is decreased or eliminated by matching the output voltage to the induced harmonic voltage. Preferably, the output voltage is specified such that a harmonic current flowing during operation, in particular in addition to a basic oscillation coil current, is at least substantially set to a value determined in at least one calibration step. In particular, the harmonic coil current is influenced by operating parameters and/or material properties and/or manufacturing tolerances and/or design and/or the like.

Preferably, at least the value for the harmonic coil current at which low noise and/or torque ripple-free operation is provided is determined in the calibration step. The phrase “harmonic” is in particular intended to mean an oscillation that is formed as a multiple, preferably an integer multiple, of the frequency of a basic oscillation. For example, the harmonic oscillation could be determined by a Fourier transformation, in particular a Fast Fourier transformation, or by a comparable mathematical method.

Preferably, the harmonic coil current is set by the open- and/or closed-loop control unit by specifying the output voltage as a function of the rotational angle of the rotor. In particular, the harmonic coil current is controlled/set by the open- and/or closed-loop control unit in an open loop system. In particular, an “open loop system” is to be understood as a control operation, preferably to control the harmonic coil voltage. In particular, the open loop system is free of feedback, for example of the coil current, within the control loop.

Further, it is proposed that the harmonic coil current is at least substantially eliminated by setting the value determined in the calibration step to zero. Advantageously, a high level of comfort can be provided, as in particular a very small/no harmonic coil current causes a particularly low noise emission. Advantageously, low costs may be provided, as the value zero in particular represents a very good approximation for many electric motors/operating conditions. Advantageously, a low calibration complexity can be provided, as the value zero in particular represents a very good approximation for most electric motors, thereby eliminating the need for calibration to determine the optimal harmonic coil current. Preferably, the electric motor is operated at least substantially free of a harmonic coil current. Preferably, the electric motor is operated with a very small harmonic coil current. In this context, “at least substantially” should be understood in particular to mean that a deviation from a specified value deviates by less than 25%, preferably less than 10%, particularly preferably less than 5%, and especially preferably less than 1% of the basic oscillation coil current.

Furthermore, it is proposed that the harmonic coil current is set by matching or at least approximating the output voltage to the harmonic coil voltage induced by the at least one permanent magnet. Advantageously, a high level of comfort can be provided, as particularly low noise emissions can be achieved, especially due to the very small harmonic coil current. Advantageously, low costs can be provided, as in particular by setting the harmonic coil current, a computing power of the open- and/or closed-loop control unit can be kept low. Preferably, a harmonic difference voltage is determined for each coil between the total coil voltage, particularly that occurring during operation, and a basic oscillation coil voltage provided by the electronic circuit, by means of which the output voltage is matched or at least approximated. Preferably, the output voltage provided by the electronic circuit is adjusted such that the electric motor is operated at least substantially free of the harmonic differential voltage or at a reduced harmonic differential voltage. In particular, by adjusting/approximating the output voltage, the harmonic differential voltage between the induced harmonic voltage and the output voltage is at least reduced. In particular, “adjusting” should be understood to mean an approximation of an actual value to a target value, in particular an alignment of two values to one another. In particular, “approximating” is to be understood to mean a reduction of a difference between two values, wherein the difference is greater than zero.

It is also proposed that a relationship between the output voltage and the rotational angle of the rotor is described by a sinusoidal path with harmonic voltage modulation, which takes into account a harmonic coil voltage oscillation, preferably harmonic voltage, generated by the at least one permanent magnet. Advantageously, a high level of comfort can be provided, as in particular a very small or no harmonic coil current causes a particularly low noise emission. Advantageously, low costs can be provided, as already existing electric motors can be improved by an update with a new, in particular a harmonic-modulated, sinusoidal path. In harmonic voltage modulation, a harmonic voltage is preferably applied to the basic oscillation coil voltage. Preferably, the harmonic voltage is configured as a harmonic, in particular integer multiple, of the basic oscillation voltage. For example, a progression of the harmonic output voltage could be configured to be at least substantially the same as the total harmonic coil voltage. In harmonic modulation, the basic oscillation coil voltage is preferably added to the harmonic coil voltage.

In addition, it is proposed that the output voltage is stored in the open- and/or closed-loop control unit based on a value table determined preferably during a calibration of the electric motor. Advantageously, a high level of comfort can be provided, as in particular a very small/no harmonic coil current causes a particularly low noise emission. Advantageously, a particularly precise operation can be provided, as an occurrence of torque fluctuations, preferably torque ripple, can be prevented in particular by adjusting the harmonic coil current. Advantageously, low costs can be provided, as already existing drives can in particular be improved with an update. Advantageously, low costs can be provided, because in particular by adjusting the harmonic coil current, a computing power of the open- and/or closed-loop control unit can be kept low. Preferably, the value table has a number of rotational angles of the rotor relative to the stator, preferably distributed evenly over one revolution, to each of which an output voltage is assigned. It is conceivable that the values in the table may be linearly interpolated to provide an output voltage signal for intermediate values of the rotational angle. For example, the relationship between the output voltage and the rotational angle of the rotor could be described as the harmonic voltage-modulated sinusoidal path, which is divided into discrete angular steps. “Discrete angular steps” refers in particular to an integer and finite number of values for the rotational angle, which are preferably spaced apart from one another and do not overlap.

Furthermore, it is proposed that the output voltage is stored in the open- and/or closed-loop control unit as an algebraic function, preferably determined during a calibration of the electric motor. Advantageously, a high level of comfort can be provided, as in particular a reduced harmonic coil current causes a particularly low noise emission. Advantageously, a particularly precise operation can be provided, as an occurrence of torque fluctuations, preferably torque ripple, can be prevented in particular by adjusting the harmonic coil current. Advantageously, low costs can be provided, as already existing drives can in particular be improved with an update. Advantageously, low costs can be provided, because in particular by adjusting the harmonic coil current, a computing power of the open- and/or closed-loop control unit can be kept low. For example, the relationship between the output voltage and the rotational angle of the rotor could be described as the harmonic voltage-modulated sinusoidal path, which is described with the algebraic function exactly or at least approximately. In particular, an “algebraic function” is intended to mean a mathematical relationship between two amounts, which are continuously described at least in a range of values.

In addition, it is proposed that the relationship between the output voltage and the rotational angle of the motor is specified depending on at least one operating parameter, in particular a motor load, motor speed, motor temperature, and/or operating voltage. Advantageously, a particularly high level of comfort can be provided, as taking into account the operating parameters in particular causes a particularly low noise emission. Preferably, the harmonic coil current value of at least one of the operating parameters is influenced.

Additionally, it is proposed that a plurality of value tables or a set of algebraic functions are associated with various operating states, which are selected during operation depending on the operating parameters. Advantageously, a particularly high level of comfort can be provided, as taking into account the operating parameters in particular causes a particularly low noise emission, preferably in all operating states. Preferably, a plurality of value tables is stored in the open- and/or closed-loop control unit, which can be selected to set the output voltage depending on the operating states and/or the operating parameters. Preferably, each value table is associated with a range of values of the operating state and/or the operating parameter. Alternatively, a set of algebraic functions could be stored in the open- and/or closed-loop control unit, which can be matched to operating states and/or operating parameters via parameterization, for example. It is conceivable that the parameterized set of algebraic functions can be used to continuously adapt to operating conditions and/or operating parameters.

Furthermore, a calibration method is proposed for a parameter determination, in particular for the control method, wherein the calibration step is performed, preferably individually, for each motor. Advantageously, a high level of comfort can be provided, as operation with the output voltages determined by the calibration in particular ensures a particularly low noise operation of the electric motor. Preferably, a value for the harmonic coil current is determined in at least a sub-step of the calibration step. Preferably, the value of the harmonic coil current represents an optimal value at which an NVH load is low and torque ripple is minimized. Preferably, the optimum value for the harmonic coil current is determined, for example, for an electric motor, for example by averaging several electric motors of a series, and transferred to all electric motors of the series in a serial production. Alternatively, it would be conceivable that the optimal value in a manufacturing process is performed individually for each electric motor. It is also conceivable that the optimal value is determined again each time the electric motor is repaired/serviced, for example by performing a recalibration. Preferably, in at least a further sub-step of the calibration step, the output voltages are determined at which the electric motor is operated at least substantially with the value of the harmonic coil current. Preferably, in the further calibration step, the electric motor is operated such that the harmonic coil current is regulated and the output voltages for the rotational angles are read out in order to achieve the value for the harmonic coil current. Preferably, in a further sub-step of the calibration step, the determined output voltages are provided to the open- and/or closed-loop control unit. It is conceivable that calibration may reduce an impact of manufacturing tolerances on the NVH emission. In particular, “parameters” should be understood to mean the output voltages as a function of the rotational angle of the rotor relative to the stator.

Furthermore, an electric motor is proposed using the control method described above. Advantageously, a high level of comfort can be provided, as the electric motor in particular allows a particularly low noise operation. Advantageously, an electric motor can be provided at a low cost, as in particular, only a low computing power is required by the control method of the electric motor and a cost-efficient open- and/or closed-loop control unit can thereby be installed.

The control method according to the invention, the calibration method and the electric motor according to the invention are not intended to be limited to the application and embodiment described hereinabove. In particular, the control method according to the invention, the calibration method according to the invention and/or the electric motor according to the invention can comprise a number of individual elements, components, units, and method steps that deviates from a number specified herein for fulfilling a function described herein. Moreover, regarding the ranges of values indicated in this disclosure, values lying within the limits specified hereinabove are also intended to be considered as disclosed and usable as desired.

Further advantages follow from the description of the drawings hereinafter. The drawings illustrate an exemplary embodiment of the invention. The drawings, the description, and the claims contain numerous features in combination. A person skilled in the art will appropriately also consider the features individually and combine them into additional advantageous combinations.

### BRIEF DESCRIPTION OF THE DRAWINGS

Shown are:

FIG. 1 an electric motor having a rotor and with a stator,

FIG. 2 a schematic replacement circuit diagram of the electric motor with a harmonic coil current,

FIG. 3 a schematic representation of an oscillation diagram,

FIG. 4 a schematic flowchart of a control method for the electric motor; and

FIG. 5 a schematic flowchart of a calibration method.

### DETAILED DESCRIPTION

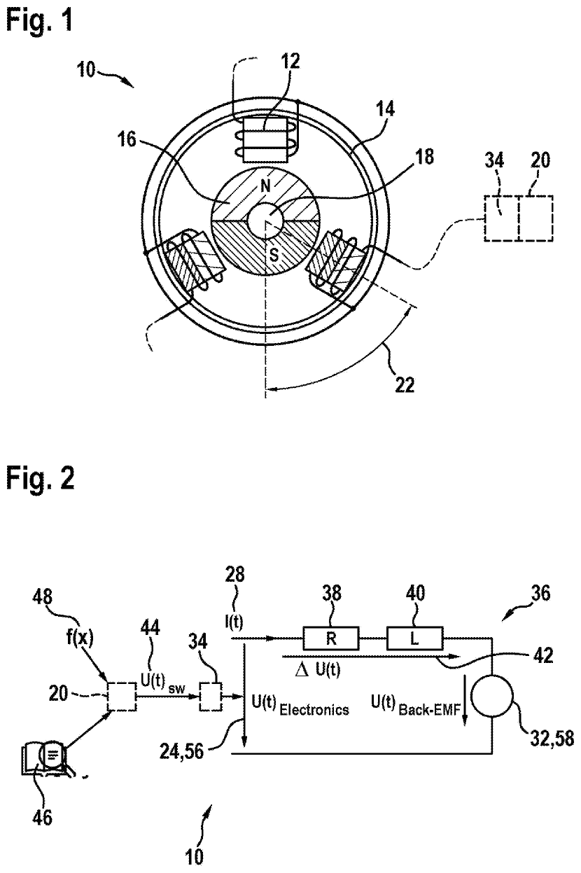

FIG. 1 shows an electric motor 10. The electric motor 10 is designed as a brushless DC motor. The electric motor 10 is configured as a permanent-magnet-excited synchronous motor. The electric motor 10 is configured as an internal rotor electric motor. The electric motor 10 could also be configured as an external rotor electric motor. The electric motor 10 has a stator 14. The stator 14 comprises three coils 12. The three coils 12 are arranged offset from one another by an electrical angle of 120°. Alternatively, the stator 14 could also comprise one of three different numbers of coils 12. The electric motor 10 has a rotor 18. The rotor 18 has an electrical rotational angle 22 relative to the stator 14. The electrical rotational angle 22 has a value between 0° and ±360°. When the rotor 18 rotates, the rotational angle 22 repeats itself with each revolution. The rotor 18 comprises two permanent magnets 16. The two permanent magnets 16 have different poles. The electric motor 10 could also have one of two different numbers of permanent magnets 16. The electric motor 10 comprises an open- and/or closed-loop control unit 20. The open- and/or closed-loop control unit 20 is configured as a microprocessor. The open- and/or closed-loop control unit 20 is configured to output an output voltage signal 44 to a controller of the electric motor 10 as a function of the rotational angle 22 of the rotor 18 to the stator 14, cf. FIG. 2. The electric motor 10 has an electronic circuit 34. The electronic circuit 34 is configured as an inverter circuit. The inverter circuit is adapted to convert a DC current to an electrical power supply of the electric motor 10 into a multi-phase AC current. The multi-phase AC current is configured to be three-phase. The electronic circuit 34 provides an output voltage 24 to the coils 12, cf. FIG. 2. The electronic circuit 34 converts the output voltage signal 44 specified by the open- and/or closed-loop control unit 20 into an output voltage 24.

FIG. 2 shows a schematic replacement circuit diagram 36 of the electric motor 10. The open- and/or closed-loop control unit 20 has a value table 46. Alternatively or additionally, the open- and/or closed-loop control unit 20 could also have an algebraic function 48. The value table 46 or algebraic function 48 has a relationship between the rotational angle 22 and the output voltage signal 44. The open- and/or closed-loop control unit 20 provides the associated output voltage signal 44 to the electronic circuit 34 for the rotational angle 22 of the rotor 18. The electronic circuit 34 converts the output voltage signal 44 into the output voltage 24. The electric motor 10 is driven by the output voltage 24. The electric motor 10 has a resistance 38.

The electric motor 10 has an inductance 40. In the case of a relative movement between the rotor 18 and the stator 14, a coil voltage 58 is created on the coils 12, (cf. FIG. 1). The coil voltage 58 has an induced harmonic coil voltage 32. The induced harmonic coil voltage 32 is configured as a harmonic differential voltage 42 between the output voltage 24 and a coil voltage 58. The harmonic differential voltage 42 causes a harmonic coil current 28. The harmonic coil current 28 causes increased NVH emission. The output voltage 24 specified by the open- and/or closed-loop control unit 20 is approximately the same as the coil voltage 58, therefore the harmonic differential voltage 42 is approximately zero. The harmonic coil current 28 generated by the harmonic differential voltage 42 is thus very small. A small harmonic coil current 28 causes a low NVH emission. Alternatively, the harmonic coil current 28 could be set to an optimal value. The optimal value for the harmonic coil current 28 reduces the NVH emission and prevents torque fluctuations (torque ripple).

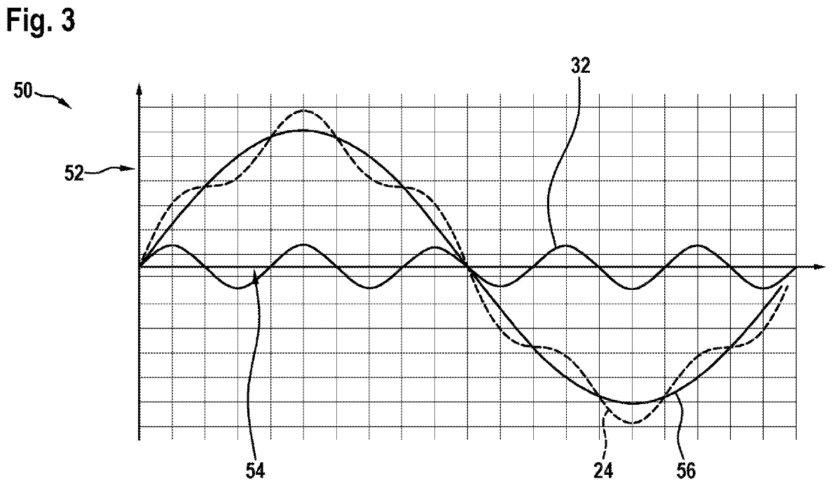

FIG. 3 shows a schematic oscillation diagram 50. The schematic oscillation diagram 50 has an ordinate 52. An electric voltage is applied to the ordinate 52. The schematic oscillation diagram 50 has an abscissa 54. On the abscissa 54, the rotational angle 22 of the rotor 18 is applied to the stator 14. The schematic oscillation diagram 50 shows the relationship between the rotational angle 22 and the output voltage 24. The output voltage 24 has a harmonic-modulated sinusoidal path. The output voltage 24 is formed by a basic oscillation coil voltage 56 added to the induced harmonic coil voltage 32. The harmonic differential voltage 42 becomes zero due to the oscillation-modulated output voltage 24. During operation, the electric motor 10 does not have any additional harmonic coil current 28 when the differential harmonic voltage 42 is zero. The electric motor 10 thus only has a sinusoidal basic oscillation coil current. Alternatively, by adjusting an amplitude and/or a phase in the harmonic modulation of the sinusoidal basic oscillation coil voltage 56, any harmonic coil current 28 can be set.

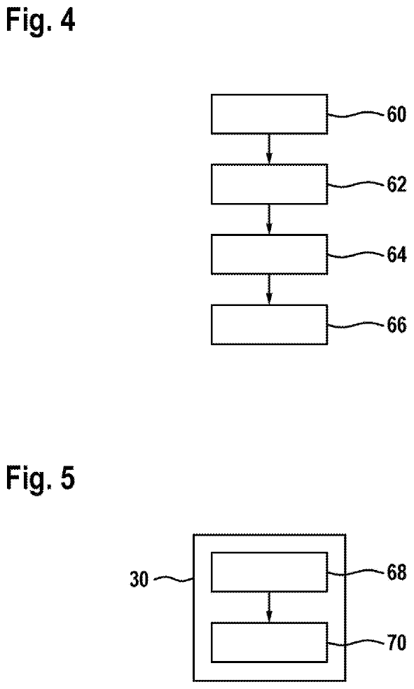

FIG. 4 shows a schematic flow diagram of a control method for the electric motor 10.

In a method step 60, the rotational angle 22 from the rotor 18 to the stator 14 is determined. The rotational angle 22 is determined at regular intervals. The determined rotational angle 22 is transmitted to the open- and/or closed-loop control unit 20. In addition, further operating parameters could be transmitted to the open- and/or closed-loop control unit 20. The operating parameters could be configured as a motor load and/or motor speed and/or a motor temperature and/or an operating voltage and/or other parameters that may appear useful to those skilled in the art.

In a further method step 62, the open- and/or closed-loop control unit 20 reads out the output voltage signal 44 associated with the transmitted rotational angle 22 from the value table 46. The output voltage signal 44 is linearly interpolated when the transmitted rotational angle 22 is between two values for the rotational angle 22. Alternatively, the output voltage signal 44 from the open- and/or closed-loop control unit 20 could be calculated using the algebraic function 48 as a function of the transmitted rotational angle 22. The relationship between the output voltage 24 and the rotational angle 22 of the rotor 18 relative to the stator 14 is described by a sinusoidal path with harmonic modulation. The output voltage 24 is specified by the open- and/or closed-loop control unit 20 such that a harmonic coil current 28 flowing during operation in addition to a basic oscillation coil current is set to a value determined in a calibration step 30. The harmonic coil current 28 is set by matching the output voltage 24 to the harmonic coil voltage 32 induced by the permanent magnets 16. The harmonic coil current 28 is eliminated by setting the value determined in the calibration step 30 to zero. The harmonic coil current 28 is eliminated by specifying the output voltage 24 such that the harmonic differential voltage 42 is zero.

It is conceivable that the open- and/or closed-loop control unit 20 has a plurality of value tables 46. In so doing, a value table 46 is associated with one of a plurality of different operating states. As a result, the relationship between the output voltage 24 and the rotational angle 22 of the electric motor 10 could be specified depending on an operating parameter. During operation, a value table 46 could be selected depending on the operating parameters. Alternatively, the open- and/or closed-loop control unit 20 could have a set of algebraic functions 48. In so doing, an algebraic function 48 could be associated with one of the various operating states. During operation, a value table 46 could be selected depending on the operating parameters.

In a further method step 64, the output voltage signal 44 is specified to the electronic circuit 34. The output voltage 24 is generated by the electronic circuit 34. A three-phase AC current is generated by the electronic circuit 34. The three-phase AC current is generated with a harmonic modulated sinusoidal path.

In a further method step 66, the rotor 18 is driven by the output voltage 24 set at the coils 12. The rotor 18 is rotated relative to the stator 14 during operation.

FIG. 5 shows a schematic flow diagram of a calibration method for a parameter determination for the control method. In the calibration method, the value table 46 of the electric motor 10 is determined. Alternatively, the algebraic function 48 is determined during the calibration of the electric motor 10.

In a sub-step 68 of the calibration step 30, a value for the harmonic coil current 28 superposed on the basic oscillation coil current is determined. The value of the harmonic coil current 28 optimizes the operation of the electric motor 10. The calibration step 30 is performed individually for each electric motor 10. Alternatively, it is conceivable that the calibration step 30 is performed once for each type of electric motor 10 and the determined value is then applied to each electric motor 10 of the same type. Alternatively, it is conceivable that the sub-step 68 of the calibration step 30 is performed on a plurality of identical electric motors 10 and the determined value is applied as the average value to all electric motors 10. Alternatively, the value/average could be redetermined at regular intervals and applied to the electric motors 10. Alternatively, it is also conceivable that the value/average value is determined for each production line/batch or the like. Further, it is conceivable that the calibration step 30 is performed after maintenance/inspection and/or at regular intervals.

In a further sub-step 70 of the calibration step 30, the output voltages 24 are determined in which the electric motor 10 is operated at the value of the harmonic coil current 28. The output voltages 24 determined in the further sub-step 70 are implemented as a value table 46 or as an algebraic function 48 in the open- and/or closed-loop control unit 20. It is conceivable that output voltages 24 are determined for various operating parameters. The value table 46 or the set of algebraic functions 48 determined as a result with the output voltages 24 depending on the rotational angle 22 of the rotor 18 are implemented in the open- and/or closed-loop control unit 20.

1. A control method for an electric motor (10), comprising a stator (14) having a coil (12) and comprising a rotor (18) having a permanent magnet (16), which rotor, during operation, is rotated relative to the stator (14), and comprising an open- and/or closed loop control unit (20) by means of which, depending on a rotational angle (22) to the rotor (18) to the stator (14), an output voltage (24) for driving the rotor (18) is specified, the method comprising specifying the output voltage (24) such that a harmonic coil current (28) flowing during operation is set at least substantially to a value determined in a calibration step (30).

2. The control method according to claim 1, wherein the harmonic coil current (28) is at least substantially eliminated by setting the value determined in the calibration step (30) to zero.

3. The control method according to claim 1, wherein the harmonic coil current (28) is set by matching the output voltage (24) to the coil voltage (32) induced by the permanent magnet (16).

4. The control method according to claim 1, wherein a relationship between the output voltage (24) and the rotational angle (22) of the rotor (18) to the stator (14) is described by a sinusoidal path with harmonic modulation, which takes into account a harmonic oscillation of the coil voltage (32) induced by the permanent magnet (16).

5. The control method according to claim 1, wherein the output voltage (24) is stored in an open- /or closed-loop control unit (20) based on a value table (46) determined during a calibration of the electric motor (10).

6. The control method according to claim 1, wherein the output voltage (24) is stored in an open- and/or closed-loop control unit (20) as an algebraic function (48) determined preferably during a calibration of the electric motor (10).

7. The control method according to claim 1, wherein a relationship between the output voltage (24) and the rotational angle (22) of the electric motor (10) is specified depending on an operating parameter.

8. The control method according to claim 7, wherein a plurality of value tables (46) or a set of algebraic functions (48) are associated with different operating states, which are selected during the operation depending on the operating parameters.

9. The control method according to claim 1, wherein the calibration step (30) is performed for each electric motor (10).

10. An electric motor (10) having a control method according to claim 1.
